(19) United States
(12) Patent Application Publication
(10) Pub. No.: US 2025/0368842 A1
(43) Pub. Date: Dec. 4, 2025

(54) AQUEOUS INK, INK CARTRIDGE, INK JET RECORDING METHOD, AQUEOUS PIGMENT DISPERSION, METHOD FOR PRODUCING AQUEOUS PIGMENT DISPERSION, AND METHOD FOR PRODUCING AQUEOUS INK

(71) Applicant: CANON KABUSHIKI KAISHA, Tokyo (JP)

(72) Inventors: HIROMITSU KISHI, Kanagawa (JP); YOSHITAKA TORISAKA, Tokyo (JP); TAKAHIRO TAJIMA, Kanagawa (JP); KENTA OHTSUKA, Kanagawa (JP)

(21) Appl. No.: 19/220,622

(22) Filed: May 28, 2025

(30) Foreign Application Priority Data
May 29, 2024 (JP) 2024-087315
May 22, 2025 (JP) 2025-085557

(51) Int. Cl. C09D 11/32; C08K 5/3465; C09B 67/20; C09B 67/54

(52) U.S. Cl. CPC C09D 11/32; C08K 5/3465; C09B 67/0066; C09B 67/0096; C08K 2201/006

(57) ABSTRACT

The aqueous ink includes a pigment, a resin dispersant and an aqueous medium. The pigment contains C.I. Pigment Orange 43. The aqueous ink has an absorbance ratio of 0.95 or more to 1.15 or less, which is represented by the following equation (1). An absorbance of 50% by mass of an upper layer when the aqueous ink is centrifuged at 217,000 G for 30 minutes at a pigment content of 1.5% by mass is less than 0.20 in a wavelength range of 350 nm or more to 550 nm or less.

$$Absorbance ratio = absorbance at peak around wavelength of 532 nm / absorbance at peak around wavelength of 496 nm \qquad ( 1 )$$

### BACKGROUND

### Field of the Technology

The present disclosure relates to an aqueous ink, an ink cartridge, an ink jet recording method, an aqueous pigment dispersion, a method for producing an aqueous pigment dispersion, and a method for producing an aqueous ink.

### Description of the Related Art

A pigment ink for ink jet recording is generally based on four colors: black in addition to the basic three primary colors of yellow, magenta and cyan. In addition to those colors, inks of intermediate colors, such as red, green, blue, orange and violet, are used to expand a color gamut. Various kinds of pigments are used in an ink jet recording method. For example, for an ink having an orange hue, C.I. Pigment Orange 43 is used as a pigment having a perinone skeleton.

As a pigment dispersion using C.I. Pigment Orange 43, for example, in International Publication No. WO2018/168486, there has been proposed an aqueous pigment dispersion that may be used for production of an ink, in which a coarse particle is reduced, and which is excellent in pigment dispersibility and storage stability at a level that is less liable to cause changes in physical properties over time.

In addition, in Japanese Patent Laid-Open No. 2019-155679, there is a disclosure of such an ink jet recording method that when an ink containing C.I. Pigment Orange 43 is ejected from a recording head through the action of thermal energy, the ejection stability of the ink is satisfactory, and an image having satisfactory color developability can be recorded with the ink. In the ink jet recording method, there has been proposed the use of an aqueous ink containing C.I. Pigment Orange 43, calcium and a resin having an anionic group.

Meanwhile, in Japanese Patent Laid-Open No. 2006-77177, there has been proposed a dispersion liquid for ink jet recording in which the absorbance of a separated liquid after centrifugation at a wavelength of 250 nm falls within a range of from 0.001 to 1.0 so that the storage stability is excellent and the ejection stability is satisfactory without foaming or thickening.

### SUMMARY

The present disclosure is directed to providing such an aqueous ink for ink jet recording including C.I. Pigment Orange 43 that the ejection stability is satisfactory, and an image having satisfactory color developability can be recorded. The present disclosure is also directed to providing an ink cartridge containing the aqueous ink and an ink jet recording method using the aqueous ink. The present disclosure is also directed to providing an aqueous pigment dispersion that can be used in the production of an aqueous ink, a method for producing an aqueous pigment dispersion that can be used in the production of an aqueous ink, and a method for producing an aqueous ink using the aqueous dispersion obtained by the production method, the aqueous ink having the ejection stability is satisfactory, and an image having satisfactory color developability can be recorded.

That is, according to one aspect of the present disclosure, there is provided an aqueous ink for ink jet recording, including: a pigment; a resin dispersant; and an aqueous medium, wherein the pigment contains C.I. Pigment Orange 43, wherein the aqueous ink has an absorbance ratio of 0.95 or more to 1.15or less, which is represented by the following equation (1):

$$absorbance ratio = absorbance at peak around wavelength of 532 nm / absorbance at peak around wavelength of 496 nm , and \qquad ( 1 )$$

wherein an absorbance of 50% by mass of an upper layer when the aqueous ink is centrifuged at 217,000 G for 30 minutes at a pigment content of 1.5% by mass is less than 0.20 in a wavelength range of 350 nm or more to 550 nm or less.

In addition, according to another aspect of the present disclosure, there is provided an ink cartridge including: an ink; and an ink storage portion configured to store the ink, wherein the ink comprises the above-mentioned aqueous ink.

In addition, according to another aspect of the present disclosure, there is provided an ink jet recording method of recording an image onto a recording medium by ejecting an ink from an ink jet recording head, wherein the ink comprises the above-mentioned aqueous ink.

In addition, according to one aspect of the present disclosure, there is provided an aqueous pigment dispersion used in a production of an aqueous ink for ink jet recording, including: a pigment; a resin dispersant; and an aqueous medium, wherein the pigment contains C.I. Pigment Orange 43, wherein the aqueous pigment dispersion has an absorbance ratio of 0.95 or more to 1.15 or less, which is represented by the following equation (1):

$$absorbance ratio = absorbance at peak around wavelength of 532 nm / absorbance at peak around wavelength of 496 nm , and \qquad ( 1 )$$

wherein an absorbance of 50% by mass of an upper layer when the aqueous pigment dispersion is centrifuged at 217,000 G for 30 minutes at a pigment content of 1.5% by mass is less than 0.20 in a wavelength range of 350 nm or more to 550 nm or less.

In addition, according to another aspect of the present disclosure, there is provided a method for producing an aqueous pigment dispersion used in a production of an aqueous ink for ink jet recording, including: a step A of performing solvent salt milling by mixing at least a raw material pigment, an inorganic salt and an organic solvent; a step B of subjecting a mixture containing the pigment obtained in the step A, a resin dispersant and an aqueous medium to dispersion treatment to provide a dispersion; and a step C of subjecting the dispersion obtained in the step B to ultrafiltration treatment to provide an aqueous pigment dispersion, wherein the raw material pigment contains C.I. Pigment Orange 43 having a BET specific surface area of 35 m²/g or less, wherein the aqueous pigment dispersion has an absorbance ratio of 0.95 or more to 1.15 or less, which is represented by the following equation (1):

$$absorbance ratio = absorbance at peak around wavelength of 532 nm / absorbance at peak around wavelength of 496 nm , and \qquad ( 1 )$$

wherein an absorbance of 50% by mass of an upper layer when the aqueous pigment dispersion is centrifuged at 217,000 G for 30 minutes at a pigment content of 1.5% by mass is less than 0.20 in a wavelength range of 350 nm or more to 550 nm or less.

In addition, according to another aspect of the present disclosure, there is provided a method for producing an aqueous ink for ink jet recording, including mixing the aqueous pigment dispersion produced by the above-mentioned method and another ink component.

Features of the present disclosure will become apparent from the following description of embodiments with reference to the attached drawings. The following description of embodiments are described by way of example.

### BRIEF DESCRIPTION OF THE DRAWINGS

FIG. 1 is a sectional view for schematically illustrating an ink cartridge according to one embodiment of the present disclosure.

FIG. 2A is a perspective view for schematically illustrating an example of the main portion of an ink jet recording apparatus to be used in an ink jet recording method of the present disclosure.

FIG. 2B is a perspective view for schematically illustrating an example of a head cartridge of the ink jet recording apparatus to be used in the ink jet recording method of the present disclosure.

### DESCRIPTION OF THE EMBODIMENTS

The present disclosure is described in more detail below by way of exemplary embodiments. In addition, physical property values are values at normal temperature (25° C.), normal pressure (1 atm=101,325 Pa) and normal humidity (relative humidity: 50%) unless otherwise stated. In addition, the “unit” of a resin dispersant means a unit structure corresponding to one monomer unless otherwise stated. The terms “(meth)acrylic acid” and “(meth)acrylate” refer to “acrylic acid and methacrylic acid,” and “an acrylate and a methacrylate,” respectively. In addition, an aqueous pigment dispersion used in a production of an aqueous ink for ink jet recording and an aqueous ink for ink jet recording are sometimes simply referred to as “pigment dispersion” and “ink”, respectively.

The inventors of the present disclosure investigated the aqueous pigment dispersion including C.I. Pigment Orange 43 proposed in International Publication No. WO2018/168486. As a result, it was true that when C.I. Pigment Orange 43 was miniaturized, a coarse particle was reduced, and the improvement of dispersibility in the aqueous pigment dispersion was recognized. However, meanwhile, it was found that when an aqueous ink prepared through use of the above-mentioned aqueous pigment dispersion was ejected from a recording head through the action of thermal energy, foreign matter was generated, for example, in the vicinity of an ejection orifice of the recording head, and ejection stability became insufficient. In addition, even when calcium ions were added to an ink with reference to the aqueous ink proposed in Japanese Patent Laid-Open No. 2019-155679, the ejection stability was insufficient.

Further, the inventors of the present disclosure investigated the dispersion liquid proposed in Japanese Patent Laid-Open No. 2006-77177. As a result, it was found that when the absorbance of the separated liquid after centrifugation fell within the specified range, the resin content in the dispersion liquid was extremely low, and the ejection stability was still insufficient.

Thus, the inventors of the present disclosure have made extensive investigations on such an aqueous ink including C.I. Pigment Orange 43 that the ejection stability of the ink is satisfactory, and an image having satisfactory color developability can be recorded with the ink. Thus, the inventors have reached the present disclosure.

The inventors of the present disclosure have first investigated the cause of the tendency of insufficient ejection stability when an ink prepared through use of the aqueous pigment dispersion including C.I. Pigment Orange 43 is ejected from the recording head through the action of thermal energy. As a result, it has been found that the main cause is the adhesion of foreign matter containing C.I. Pigment Orange 43 as a main component to the flow path of the recording head and the vicinity of an ejection orifice thereof. When the ink ejection stability is insufficient, so-called ejection irregularity in which the ejection direction of ink droplets deviates occurs, resulting in unevenness in an image to be recorded.

One of the possible reasons why foreign matter is liable to adhere is that C.I. Pigment Orange 43 is a pigment that tends to undergo crystal growth. It is conceived that C.I. Pigment Orange 43 tends to undergo crystal growth because of its highly planar molecular structure, which facilitates a x-x interaction, and an interaction between the fused heterocyclic ring moieties and high molecular symmetry that accelerates packing. In addition, C.I. Pigment Orange 43 is also known as C.I. Vat Orange 7 as another name and is a compound classified as a building dye. Thus, the following possibility is also conceived: part of C.I. Pigment Orange 43 is denatured into a form such as a leuco form by a high heat environment at the time of ejection and an influence from an anionic resin dispersant, and is dissolved in a monomolecular state.

From the above-mentioned characteristics, it is assumed that C.I. Pigment Orange 43 accelerates crystal growth, and adhesion and deposition of foreign matter through processes, such as aggregation and fusion of pigment particles, and precipitation and recrystallization of a dissolved monomolecular-like compound.

It has been found that, in the technology as disclosed in International Publication No. WO2018/168486, a coarse particle is reduced by subjecting C.I. Pigment Orange 43 to solvent salt milling, but a large amount of a fine particle that is miniaturized more than necessary is also generated. It has been found that such fine particle causes crystal growth and formation of foreign matter to be accelerated to decrease the ejection stability.

In addition, in the technology as disclosed in Japanese Patent Laid-Open No. 2019-155679, the decomposition of C.I. Pigment Orange 43 is suppressed by the orientation of calcium ions, and the decrease in ejection stability can be suppressed. However, it has been found that when the formation of foreign matter caused by the fine particle is predominant as described above, the suppressing effect on the decomposition of C.I. Pigment Orange 43 is limited.

Further, when the amount of a fine particle of C.I. Pigment Orange 43 is small and simultaneously the resin content in the dispersion liquid is extremely low as in Japanese Patent Laid-Open No. 2006-77177, the formation of foreign matter is accelerated by a decrease in dispersion stability of a pigment and an increase in contact frequency between exposed pigment surfaces. As a result, it has been found that the ejection stability is still insufficient.

From the foregoing, the inventors of the present disclosure have newly found that, in order to ensure the ejection stability of the aqueous ink including C.I. Pigment Orange 43, it is required to reduce the fine particle of the pigment that causes the formation of foreign matter. Then, the inventors of the present disclosure have found that the amount of the fine particle can be specified by specifying an absorbance in a wavelength range related to the absorption of a pigment molecule and a particle for the separated liquid after centrifugation under specific conditions. That is, in the aqueous ink of the present disclosure, the absorbance of 50% by mass of an upper layer when the aqueous ink is centrifuged at 217,000 G for 30 minutes at a pigment content of 1.5% by mass is set to less than 0.20 in a wavelength range of 350 nm or more to 550 nm or less. When the above-mentioned absorbance in the wavelength range of 350 nm or more to 550 nm or less is 0.20 or more, the formation of foreign matter is pronounced, and the ejection stability is decreased. In the present disclosure, the above absorbance may be referred to as “absorbance after centrifugation”.

Subsequently, the inventors of the present disclosure have investigated requirements for obtaining high color developability in the aqueous ink including C.I. Pigment Orange 43. As the color developability, a preferred hue is required as well as a high chroma. In the discussion on the particle diameter of a pigment as specified in International Publication No. WO2018/168486, it has been found that the correlation is insufficient for the hue, though the correlation is obtained for the chroma to some degree.

As a result of the investigations made by the inventors of the present disclosure, it has been newly found that an absorption spectrum in a state of an aqueous ink is appropriate for discussing the color developability, and focus is required to be given on an absorption band on the longest wavelength side, in particular, among four absorption bands exhibited by C.I. Pigment Orange 43. The absorption band on the longest wavelength side is significantly dependent on an interaction between pigment molecules. From the foregoing, when the absorption band is larger than necessary, a decrease in color development efficiency occurs owing to a large crystal size or the aggregation of crystals, and a wide spectrum shape leads to a decrease in chroma also from the viewpoint of color purity. In addition, the hue shifts in a red direction. In contrast, when the absorption band on the longest wavelength side is smaller than necessary, two absorption bands on a short wavelength side are also slightly increased while the chroma is improved, and hence the hue largely shifts in a yellow direction. As a result, the original characteristic of C.I. Pigment Orange 43, which is a reddish orange color, is impaired. Further, it has been found that the formation of foreign matter also decreases the ejection stability.

As described above, it has been found that, in order to relatively compare the magnitudes of the absorption band on the longest wavelength side, which has large influences on the color developability and the ejection stability, an absorbance ratio normalized based on the size of an absorption band on the second longest wavelength side is appropriate. That is, in the aqueous ink of the present disclosure, the ratio (absorbance ratio) of an absorbance at a peak around a wavelength of 532 nm (first peak from the long wavelength side) to an absorbance at a peak around a wavelength of 496 nm (second peak from the long wavelength side) is set to 0.95 or more to 1.15 or less. When the above-mentioned absorbance ratio is less than 0.95, the hue shifts in a yellow direction while the chroma is improved. As a result, the original characteristic of C.I. Pigment Orange 43, which is a reddish orange color, is impaired. Further, the formation of foreign matter also decreases the ejection stability. In addition, when the above-mentioned absorbance ratio is more than 1.15, a decrease in color development efficiency occurs owing to a large crystal size or the aggregation of crystals, and such absorbance ratio leads to a decrease in chroma. Further, the hue shifts in a red direction.

In addition, in the aqueous pigment dispersion used in a production of the aqueous ink for ink jet recording, it is important that an absorbance of 50% by mass of an upper layer when the aqueous pigment dispersion is centrifuged at 217,000 G for 30 minutes at a pigment content of 1.5% by mass be less than 0.20 in a wavelength range of 350 nm or more to 550 nm or less. A particle of approximately less than 30 nm is captured because 50% by mass of the upper layer of a sample is collected. The inventors of the present disclosure have found that when such particle is treated as a fine particle, and the absorbance in the wavelength range of 350 nm or more to 550 nm or less, which is caused by this fine particle, is 0.20 or more, the formation of foreign matter is pronounced, and the ejection stability of the ink is decreased. In addition, from the viewpoint of improving color development, it is important for the aqueous pigment dispersion used in a production of an aqueous ink for ink jet recording that the ratio (absorbance ratio) of an absorbance at peak around wavelength of 532 nm (first peak from long wavelength side) to an absorbance at peak around wavelength of 496 nm (second peak from long wavelength side) is set to 0.95 or more to 1.15 or less.

As described above, the inventors of the present disclosure have reached the disclosure of such an aqueous ink including C.I. Pigment Orange 43 that the ejection stability is satisfactory, and an image having satisfactory color developability can be recorded. Also, the inventors of the present disclosure have reached the disclosures of an ink cartridge containing the aqueous ink and an ink jet recording method. Further, the inventors of the present disclosure have reached the disclosures of an aqueous pigment dispersion that can be used in the production of an aqueous ink, a method for producing an aqueous pigment dispersion that can be used in the production of an aqueous ink, and a method for producing an aqueous ink using the aqueous dispersion obtained by the production method.

### Aqueous Pigment Dispersion

The aqueous pigment dispersion of the present disclosure includes a pigment, a resin dispersant and an aqueous medium. The pigment contains C.I. Pigment Orange 43.

### (Pigment)

The aqueous pigment dispersion includes, as the pigment, C.I. Pigment Orange 43. The aqueous pigment dispersion may include, as the pigment, C.I. Pigment Orange 43 alone, or C.I. Pigment Orange 43 and one kind or two or more kinds of other pigments. The content (% by mass) of C.I. Pigment Orange 43 (solid content) in the aqueous pigment dispersion is preferably 1.0% by mass or more to 50.0% by mass or less, more preferably 5.0% by mass or more to 30.0% by mass or less based on the total mass of the aqueous pigment dispersion.

### (Resin Dispersant)

The aqueous pigment dispersion includes a resin dispersant. The resin dispersant is a resin that disperses a pigment containing C.I. Pigment Orange 43 in the aqueous pigment dispersion. The content (% by mass) of the resin dispersant in the aqueous pigment dispersion is preferably 0.1% by mass or more to 10.0% by mass or less, more preferably 0.5% by mass or more to 5.0% by mass or less based on the total mass of the aqueous pigment dispersion. In addition, the content (% by mass) of the resin dispersant in the aqueous pigment dispersion is preferably 0.05times or more to 0.4 times or less in terms of a mass ratio to the content of the pigment. The aqueous pigment dispersion may contain one type of the resin dispersant alone or two or more type of the resin dispersants.

Examples of the resin dispersant may include an acrylic resin and a urethane-based resin. Of those, an acrylic resin is preferred. As the acrylic resin, a copolymer having a unit derived from a styrene-based monomer and a unit derived from (meth)acrylic acid is more preferred, and the copolymer may further have a unit derived from a (meth)acrylic acid ester. More specifically, a copolymer of a styrene-based monomer and (meth)acrylic acid, a copolymer of a styrene-based monomer, a (meth)acrylic acid ester and (meth)acrylic acid and copolymers in which acid groups of the above-mentioned copolymers are neutralized with basic compounds, such as potassium hydroxide and sodium hydroxide, are still more preferred. Those copolymers may be used in any of the forms of a random copolymer, a block copolymer and a graft copolymer.

The unit derived from (meth)acrylic acid is a hydrophilic unit having a carboxylic acid group that is an anionic group. The unit derived from a styrene-based monomer and the unit derived from a (meth)acrylic acid ester are hydrophobic units. Examples of the styrene-based monomer may include styrene, α-methylstyrene, 2-methylstyrene, 3-methylstyrene and 4-methylstyrene. The styrene-based monomers may be used alone or in combination thereof. Examples of the (meth)acrylic acid ester may include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, 2-ethylhexyl (meth)acrylate and benzyl (meth)acrylate. In the acrylic resin, the (meth)acrylic acid esters may be used alone or in combination thereof.

The ratio (% by mass) of the unit derived from a styrene-based monomer to the total mass of the resin dispersant is more preferably 60% by mass or more to 77% by mass or less. When the ratio of the unit derived from a styrene-based monomer in the resin dispersant falls within the above-mentioned range, the interaction with the x-plane of C.I. Pigment Orange 43 is improved, and the adsorption of the resin dispersant is strengthened. As a result, the ejection stability is further improved. In addition, when the ratio of the unit derived from a styrene-based monomer in the resin dispersant falls within the above-mentioned range, the ejection stability is also further improved because the fine particle of a pigment is satisfactorily removed in ultrafiltration treatment in a step C of a method for producing an aqueous pigment dispersion described later.

The acid value of the resin dispersant is preferably 150 mgKOH/g or more to 210 mgKOH/g or less, more preferably 160 mgKOH/g or more to 200mgKOH/g or less. When the acid value of the resin dispersant is 160 mgKOH/g or more, the fine particle of the pigment is easily removed in the ultrafiltration treatment in the step C of the method for producing an aqueous pigment dispersion described later, and hence the ejection stability is further easily increased. Meanwhile, when the acid value of the resin dispersant is 200 mgKOH/g or less, the color developability of an image to be recorded is further easily increased. As used herein, the acid value of the resin dispersant may take a value measured with a potentiometric titration device using a potassium hydroxide-ethanol titrant.

The weight-average molecular weight (Mw) of the resin dispersant is preferably 1,000 or more to 30,000 or less, more preferably 5,000 or more to 15,000or less. As used herein, the weight-average molecular weight of the resin dispersant may take a value in terms of polystyrene measured by gel permeation chromatography (GPC).

### (Aqueous Medium)

The aqueous pigment dispersion includes an aqueous medium containing at least water. Water alone or an aqueous medium containing water serving as a main solvent and a protic or aprotic organic solvent in combination therewith may be used as the aqueous medium. An organic solvent that is mixed with or dissolved in water at an appropriate ratio is preferably used as the organic solvent. In particular, a homogeneous mixed solvent containing 50% by mass or more of water is preferably used as the aqueous medium. Ion-exchanged water or pure water is preferably used as the water. The content (% by mass) of the water in the aqueous pigment dispersion is preferably 50.0% by mass or more to 95.0% by mass or less, more preferably 50.0% by mass or more to 90.0% by mass or less based on the total mass of the aqueous pigment dispersion.

The protic organic solvent is an organic solvent having hydrogen atoms (acidic hydrogen atoms) bonded to oxygen or nitrogen. In addition, the aprotic organic solvent is an organic solvent that does not have acidic hydrogen atoms. Examples of the organic solvent may include: alcohols; alkylene glycols; polyalkylene glycols; glycol ethers; glycol ether esters; carboxylic acid amides; ketones; keto-alcohols; cyclic ethers; nitrogen-containing compounds; and sulfur-containing compounds. Those organic solvents may be used alone or in combination thereof. When the organic solvent is used, the organic solvent may be removed in post-treatment. For example, the organic solvent may be removed by decompression or heating through use of an evaporator.

### (Characteristics of Aqueous Pigment Dispersion)

### [Absorbance Ratio]

The aqueous pigment dispersion has an absorbance ratio of 0.95 or more to 1.15 or less, which is represented by the following equation (1):

$$absorbance ratio = absorbance at peak around wavelength of 532 nm / absorbance at peak around wavelength of 496 nm . \qquad ( 1 )$$

Among the four absorption bands exhibited by C.I. Pigment Orange 43, the absorption band on the longest wavelength side is a peak around a wavelength of 532 nm, and the absorption band on the second longest wavelength side is a peak around a wavelength of 496 nm. The absorbance ratio is calculated by diluting the aqueous pigment dispersion by 10,000 times with ion-exchanged water and measuring an absorption spectrum in a wavelength range of 200 nm or more to 800 nm or less. For example, a spectrophotometer (product available under the product name “U-3300” from Hitachi, Ltd.) may be used in the measurement of the absorption spectrum.

When the absorbance ratio is more than 1.15, a decrease in color development efficiency occurs because of a large crystal size or the aggregation of crystals, and a wide spectrum shape leads to a decrease in chroma also from the viewpoint of color purity. In addition, the hue shifts in a red direction. When the absorbance ratio is less than 0.95, two absorption bands on a short wavelength side are also slightly increased while the chroma is improved, and hence the hue largely shifts in a yellow direction. As a result, the original characteristic of C.I. Pigment Orange 43, which is a reddish orange color, is impaired. Further, the formation of foreign matter also decreases the ejection stability. In addition, the above-mentioned absorbance ratio is preferably 1.00 or more to 1.12 or less.

### Absorbance after Centrifugation

In the aqueous pigment dispersion, the absorbance of 50% by mass of an upper layer when the aqueous pigment dispersion is centrifuged at 217,000 G for 30 minutes at a pigment content of 1.5% by mass is less than 0.20 in a wavelength range of 350 nm or more to 550 nm or less. The above-mentioned absorbance is measured through use of a sample corresponding to 50% by mass of an upper layer when a sample of the aqueous pigment dispersion prepared so that the content of the pigment in the aqueous pigment dispersion is 1.5% by mass is centrifuged at 217,000 G for 30 minutes.

In the centrifugation, for example, a centrifuge (product available under the product name “Optima MAX-XP Ultracentrifuge” from Beckman Coulter, Inc.) and a rotor (product available under the product name “MLA-80” from Beckman Coulter, Inc.) may be used. An S value and a K factor are calculated from, for example, the maximum and minimum rotation radii and number of rotations of the rotor, the diameter and density of a particle and the density and viscosity of a solution, and centrifugation conditions are set to 56,000 rpm (217,000 G) for 30 minutes, assuming that a particle of 38 nm is settled out. A particle of approximately less than 30 nm is captured because 50% by mass of the upper layer of the sample is collected in this state. When such particle is treated as a fine particle and the absorbance in a wavelength range of 350 nm or more to 550 nm or less, which is caused by this fine particle, is 0.20 or more, the formation of foreign matter is pronounced, and the ejection stability is decreased. In addition, the above-mentioned absorbance is preferably 0.19 or less, more preferably 0.17 or less.

### Method for Producing Aqueous Pigment Dispersion

A method for producing an aqueous pigment dispersion of the present disclosure is used in a production of an aqueous ink. The method for producing the aqueous pigment dispersion includes a step A of performing solvent salt milling by mixing at least a raw material pigment, an inorganic salt and an organic solvent. In addition, the method for producing an aqueous pigment dispersion includes: a step B of subjecting a mixture containing the pigment obtained in the step A, a resin dispersant and an aqueous medium to dispersion treatment to provide a dispersion; and a step C of subjecting the dispersion obtained in the step B to ultrafiltration treatment to provide an aqueous pigment dispersion. A preferred aqueous pigment dispersion can be produced by the method for producing an aqueous pigment dispersion including the step A, the step B and the step C. Each step is described below.

### [Step A: Solvent Salt Milling]

In the step A, solvent salt milling is performed by mixing at least the raw material pigment, the inorganic salt and the organic solvent. The solvent salt milling method is a method including mechanically grinding a pigment particle with a kneader or the like in the presence of an inorganic salt (salt) and an organic solvent (solvent), and this method can efficiently miniaturize the pigment particle. The solvent salt milling method includes: a kneading step of producing a kneaded product containing a pigment, an inorganic salt and an organic solvent; and a post-step of removing the inorganic salt and the organic solvent from the kneaded product.

### Raw Material Pigment

The raw material pigment (crude pigment) to be used in the step A contains C.I. Pigment Orange 43. Specifically, coarse C.I. Pigment Orange 43, that is, C.I. Pigment Orange 43 having a BET specific surface area of 35 m2/g or less may be used in the step A. The coarse C.I. Pigment Orange 43 preferably has the BET specific surface area of 15 m²/g or more to 35 m²/g or less.

### Inorganic Salt

The inorganic salt is used for pulverizing and miniaturizing the raw material pigment in the kneading step by utilizing high hardness thereof. It is preferred that an inorganic salt that is water-soluble (water-soluble inorganic salt) be used in consideration of handling at the time of removal thereof. The water-soluble inorganic salt is not particularly limited as long as the water-soluble inorganic salt is dissolved in water. Specifically, examples thereof may include alkali metal chlorides, such as sodium chloride and potassium chloride, and polyvalent metal chlorides, such as zinc chloride and magnesium chloride. The water-soluble inorganic salts may be used alone or in combination thereof.

The volume-based cumulative 50% particle diameter (D₅₀) of the inorganic salt is preferably 1 um or more to 50 um or less. In addition, the volume-based cumulative 95% particle diameter (D95) of the inorganic salt is preferably 80 μm or less. The D₅₀ and D₉₅ of the inorganic salt refer to the diameters of particles that correspond to 50% and 95% accumulated from a small particle diameter side based on the total volume of measured particles, respectively, in a particle diameter cumulative curve. The D₅₀ and D₉₅ of the inorganic salt may each be measured with, for example, a particle size analyzer using a dynamic light scattering method.

The usage amount of the inorganic salt is preferably 3 parts by mass or more to 20 parts by mass or less, more preferably 4 parts by mass or more to 10 parts by mass or less with respect to 1 part by mass of the raw material pigment.

### Organic Solvent

The organic solvent is used for increasing the grinding effect and accelerating the miniaturization of the pigment by wetting the pigment particle and the inorganic salt in the kneading step. The organic solvent is not particularly limited as long as the foregoing can be achieved, but water-soluble organic solvents, such as alcohols, glycols and ethers, are preferred. Of those, highly viscous water-soluble organic solvents, such as ethylene glycol, diethylene glycol and polyethylene glycol, are more preferred from the viewpoint of improving the grinding effect. Among the organic solvents, one type may be used alone or two or more types may be used in combination.

The usage amount of the organic solvent is preferably 0.1 part by mass or more to 5 parts by mass or less, more preferably 0.5 part by mass or more to 2.5parts by mass or less with respect to 1 part by mass of the raw material pigment.

### (Kneading Step)

The kneading step is a step of kneading the raw material pigment while compressing the raw material pigment under a load in the presence of the above-mentioned inorganic salt and organic solvent. Examples of a device to be used in the kneading step may include a kneader, a roll mill, a ball mill, an attritor, a sand mill and a planetary mixer. Of those, a kneader is preferably used.

The temperature at which the kneading step is performed is preferably 10° C. or more to 60° C. or less. When the temperature during the kneading step is set to 60° C. or less, the speed of crystal growth of C.I. Pigment Orange 43 is suppressed, and the miniaturization easily proceeds. In addition, the period of time for which the kneading step is performed is preferably 2 hours or more to 20 hours or less, more preferably 2 hours or more to 8 hours or less.

### (Post-Step

The post-step is a step of removing the inorganic salt and the organic solvent from the kneaded product obtained in the kneading step. Specifically, when the water-soluble inorganic salt preferred as the inorganic salt and the water-soluble organic solvent preferred as the organic solvent are used, there may be given a method including loading water into the kneaded product at a predetermined ratio, and then filtering and washing the slurry. Ion-exchanged water or pure water is preferably used as the water. Examples of a filtration method may include: a method including passing a suspension obtained by adding the water to the kneaded product through an ultrafiltration membrane or a dialysis membrane to separate the inorganic salt and the organic solvent; and a method including separating the inorganic salt and the organic solvent with a high-pressure filter press. Through this step, a wet cake of a pigment composition in which the contents of the inorganic salt and the organic solvent have been reduced or from which the inorganic salt and the organic solvent have been removed is obtained.

The resultant wet cake is preferably dried so that the content of the water (water content ratio) is reduced to about 60% by mass or less. Examples of a method of removing the water may include batch or continuous drying involving performing dehydration by heating at 80° C. or more to 120° C. or less with a heating source installed in a dryer and evaporation to dryness under reduced pressure. Specific examples of the dryer may include a box-type dryer, a band dryer and a spray dryer.

### [Step B: Dispersion]

In the step B, a mixture containing the pigment obtained in the step A, a resin dispersant and an aqueous medium is subjected to dispersion treatment to provide a dispersion. The step B is a step (dispersion step) of dispersing the pigment containing C.I. Pigment Orange 43 obtained in the step A in the aqueous medium. Examples of a dispersion mode of the pigment may include a resin-dispersed pigment, a self-dispersible pigment, a resin-bonded pigment and a microcapsule pigment. Of those, a resin-dispersed pigment is preferred. The resin dispersant and the aqueous medium in the above-mentioned aqueous pigment dispersion may be used as the resin dispersant and the aqueous medium to be used in the dispersion step.

In the dispersion step, a known dispersion method, such as media dispersion or media-less dispersion, may be used. Examples of a disperser using media dispersion may include a paint shaker, a bead mill, a sand mill, a ball mill and a roll mill. Examples of a disperser using media-less dispersion may include an ultrasonic homogenizer and a high-pressure homogenizer. The dispersion step may be performed with one kind of the above-mentioned dispersers alone or with a combination of two or more kinds of the dispersers.

The temperature in the dispersion step may be appropriately set. The dispersion step is performed in the aqueous medium, and hence the temperature is preferably 0° C. or more to 100° C. or less. From the viewpoints of the generation of heat during the step and the reliability of media when the media dispersion method is utilized, the temperature is more preferably 10°° C. or more to 80° C. or less. The period of time of the dispersion step only needs to be adjusted in accordance with a device to be utilized, the concentration of the dispersion and the like, and may be appropriately set as long as the pigment is not excessively dispersed.

In addition, a preliminary dispersion step may be performed in order to mix the components containing the pigment and wet the components with the aqueous medium to facilitate dispersion. The dispersion method and device described above that may be used in the dispersion step may be utilized in the preliminary dispersion step.

### [Step C: Ultrafiltration]

In the step C, the dispersion obtained in the step B is subjected to ultrafiltration treatment to provide an aqueous pigment dispersion. The step C is a step (ultrafiltration step) of purifying the dispersion obtained in the step B through use of an ultrafiltration membrane having a specific fractional particle diameter. More specifically, the purpose of the step C is to remove the fine particle of the pigment in the dispersion (aqueous pigment dispersion) obtained in the step B. Examples of a filtration method include cross-flow filtration and dead-end filtration. A cross-flow filtration method is preferably used because fractionation performance can be maintained over a long period of time while the particle deposited on the membrane surface is scraped off by the shear force of a parallel flow. The fractional particle diameter of the ultrafiltration is preferably 30 nm or less. When the fractional particle diameter of the ultrafiltration is 30 nm or less, fine particle-removing ability can be made high while ratio for such as pigment particle having a size not necessary to be removed and the resin dispersant to pass through the filtration membrane is made low. In addition, although there is no direct correlation between the fractional particle diameter and the molecular weight cut off, when expressed as the molecular weight cut off, it is preferably 300 kDa or less. On the other hand, in order to suppress clogging of the filtration membrane and maintain the processing capacity of the ultrafiltration, the molecular weight cut off is preferably 30 kDa or less.

The ultrafiltration membrane is not particularly limited as long as the ultrafiltration membrane is a membrane having a desired fractional particle diameter. Examples thereof may include a polysulfone-based polymer membrane, an aromatic ether-based polymer membrane, a fluorine-based polymer membrane, an olefin-based polymer membrane, a cellulose-based membrane, a (meth)acrylic polymer membrane, a (meth)acrylonitrile-based polymer membrane and a vinyl alcohol-based polymer membrane. Of those, a polysulfone-based polymer membrane is preferred.

The shape of the ultrafiltration membrane is not particularly limited as long as the ultrafiltration membrane can exhibit fractionation performance. For example, various shapes, such as a hollow fiber shape, a flat membrane shape and a tube shape, may each be used as the shape of the ultrafiltration membrane. Of those, a hollow fiber shape having a large effective filtration membrane area relative to a volume thereof is preferred.

A device to be used for performing the cross-flow filtration is not particularly limited as long as the device can control the concentration of the pigment particle, a linear velocity, a filtration pressure and the like. An example of the device may be a cross-flow filtration device in which a device that supplies water as a diluent in order to keep the constant concentration of the pigment particle is integrated with a device that controls the linear velocity in a tangential direction to the ultrafiltration membrane and the pressure across the ultrafiltration membrane. The linear velocity is not particularly limited as long as the linear velocity allows separation performance to be exhibited. However, when the linear velocity is too high, stress may be applied to the pigment particle, and the aggregation and denaturation of the pigment particle are liable to occur. When the linear velocity is too low, a decrease in treatment amount and the like may occur. When the filtration pressure is too high, the membrane is liable to be clogged by the rapid formation of a cake layer. When the filtration pressure is too low, the treatment amount is decreased, and hence a decrease in productivity and the like may occur.

### Aqueous Ink for Ink Jet Recording

The aqueous pigment dispersion described above in detail may be used in a variety of applications including automotive and construction paints, printing inks such as an offset ink, a gravure ink, a flexographic ink and a silkscreen ink and inks for ink jet recording. The above-mentioned aqueous pigment dispersion is preferably used in an aqueous ink for ink jet recording out of those applications.

When the aqueous pigment dispersion is applied to the aqueous ink for ink jet recording, an aqueous ink may be prepared by adding components required for the aqueous ink for ink jet recording to the aqueous pigment dispersion. It is preferred that a water-soluble organic solvent, water and a surfactant be used as the components to be added to the aqueous pigment dispersion. Further, as required, resins for a binder purpose, such as an acrylic resin and a polyurethane-based resin, and other additives may be added to the ink.

The aqueous ink includes the above-mentioned pigment containing C.I. Pigment Orange 43, resin dispersant and aqueous medium. Also, the aqueous ink has an absorbance ratio of 0.95 or more to 1.15 or less, which is represented by the above mentioned equation (1). Further, an absorbance of 50% by mass of an upper layer when the aqueous ink is centrifuged at 217,000 G for 30 minutes at a pigment content of 1.5% by mass is less than 0.20 in a wavelength range of 350 nm or more to 550 nm or less. Absorbance ratio of the aqueous ink can be measured in the same manner as that of the aqueous pigment dispersion described in above (Characteristic of Aqueous Pigment Dispersion) except that the aqueous ink is used instead of the aqueous pigment dispersion and the aqueous ink is diluted 2,000 times with ion-exchanged water. In addition, absorbance ratio after centrifugation of the aqueous ink can be measured in the same manner as that of the aqueous pigment dispersion described in above (Characteristic of Aqueous Pigment Dispersion) except that the aqueous ink is used instead of the aqueous pigment dispersion. Furthermore, similarly to the preferable range of the absorbance ratio of the aqueous pigment dispersion, the absorbance ratio of the aqueous ink is preferably 1.00 or more to 1.12or less. In addition, similarly to the preferable range of the absorbance ratio after centrifugation of the aqueous pigment dispersion, the absorbance ratio after centrifugation of the aqueous ink is preferably 0.19 or less and more preferably 0.17 or less.

The aqueous ink may contain only C. I. Pigment Orange 43 as a pigment or may contain other one or more pigments in addition to C. I. Pigment Orange 43. In addition, among the resin dispersants mentioned above, the aqueous ink may contain one type alone or may contain two or more types. Furthermore, the aqueous ink may contain only water as the aqueous medium or may contain aqueous medium that is a mixed solvent of water and one or more water-soluble organic solvents.

The content (% by mass) of C.I. Pigment Orange 43 in the aqueous ink is preferably 0.1% by mass or more to 15.0% by mass or less, more preferably 1.0% by mass or more to 10.0% by mass or less based on the total mass of the aqueous ink. The content (% by mass) of the water in the aqueous ink is preferably 50.0% by mass or more to 95.0% by mass or less, more preferably 50.0% by mass or more to 90.0% by mass or less based on the total mass of the aqueous ink. The content (% by mass) of the water-soluble organic solvent in the aqueous ink is preferably 3.0% by mass or more to 48.0% by mass or less, more preferably 3.0% by mass or more to 25.0% by mass or less based on the total mass of the aqueous ink.

Examples of the water-soluble organic solvent that may be incorporated into the ink may include monohydric or polyhydric alcohols, alkylene glycols, glycol ethers, nitrogen-containing polar compounds and sulfur-containing polar compounds. Those water-soluble organic solvents may be used alone or in combination thereof. In addition, examples of the other additives that may be incorporated into the ink may include a pH adjuster, an antiseptic, an antifungal agent, an antioxidant, an anti-reducing agent, an evaporation accelerator and a chelating agent.

### Method of Producing Aqueous Ink

The method of producing the aqueous ink according to the present disclosure includes mixing the aqueous pigment dispersion and another ink component. The aqueous produced by aforementioned production method is used as the aqueous pigment dispersion. The another ink component may be one or more of further-added water, a water-soluble organic solvent, a surfactant, a resin, and “other additives” mentioned above. One or more thereof can be used as the another ink component. Method of producing the aqueous ink may be carried out by, for example, adding the aqueous pigment dispersion and the another ink component into a suitable container and stirring them. Conditions such as stirring speed, temperature, and time can be appropriately set according to desired conditions. The method may be combined with other known production process.

### Ink Cartridge

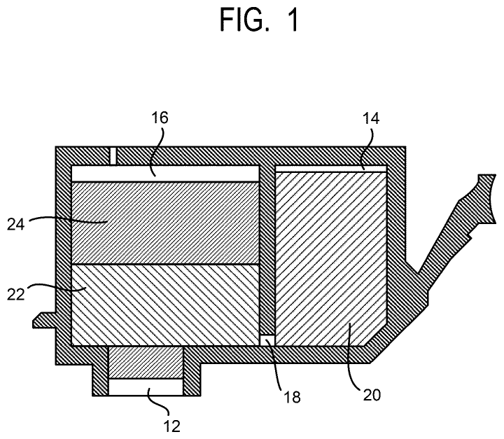

An ink cartridge of the present disclosure includes an ink and an ink storage portion that stores the ink. In addition, the ink stored in the ink storage portion is the aqueous ink of the present disclosure described above. FIG. 1 is a sectional view for schematically illustrating an ink cartridge according to one embodiment of the present disclosure. As illustrated in FIG. 1, an ink supply port 12 for supplying an ink to a recording head is arranged on the bottom surface of the ink cartridge. The inside of the ink cartridge is the ink storage portion for storing the ink. The ink storage portion includes an ink storage chamber 14 and an absorbent storage chamber 16 and the chambers communicate to each other through a communication port 18. In addition, the absorbent storage chamber 16 communicates to the ink supply port 12. While a liquid ink 20 is stored in the ink storage chamber 14, absorbents 22 and 24 each of which holds the ink in a state of being impregnated therewith are stored in the absorbent storage chamber 16. The ink storage portion may be configured to be free of an ink storage chamber that stores the liquid ink and to hold the total amount of the ink to be stored with the absorbents. In addition, the ink storage portion may be configured to be free of an absorbent and to store the total amount of the ink in a liquid state. Further, an ink cartridge configured to include the ink storage portion and a recording head may be adopted.

### Ink Jet Recording Method

An ink jet recording method of the present disclosure is a method of recording an image onto a recording medium by ejecting the aqueous ink of the present disclosure described above from an inkjet recording head. A system of ejecting the ink is, for example, a system involving applying mechanical energy to the ink or a system involving applying thermal energy to the ink. In the present disclosure, the system involving applying the thermal energy to the ink to eject the ink is particularly preferably adopted. The step of the ink jet recording method only needs to be a known step except that the ink of the present disclosure is used.

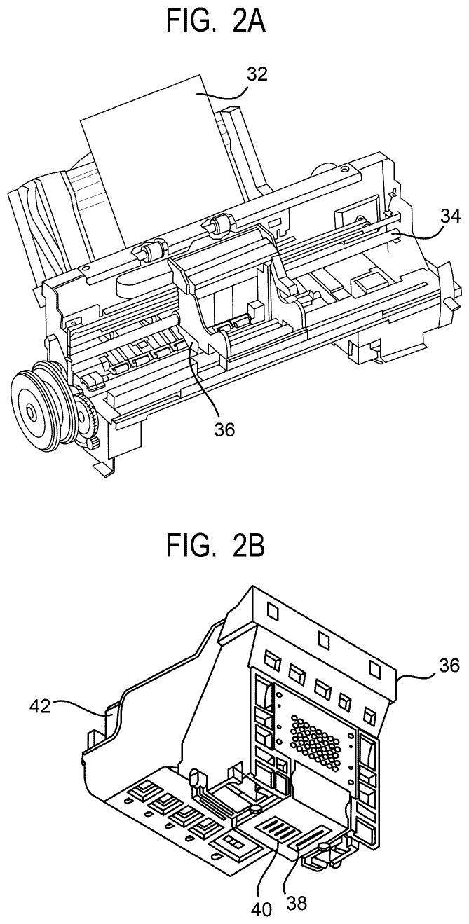

FIG. 2A and FIG. 2B are views for schematically illustrating an example of an ink jet recording apparatus to be used in the ink jet recording method of the present disclosure. FIG. 2A is a perspective view of the main portion of the ink jet recording apparatus and FIG. 2B is a perspective view of a head cartridge. A conveying unit (not shown) that conveys a recording medium 32 and a carriage shaft 34 are arranged in the ink jet recording apparatus. A head cartridge 36 may be mounted on the carriage shaft 34. The head cartridge 36 includes recording heads 38 and 40 and is formed so that an ink cartridge 42 may be set therein. While the head cartridge 36 is conveyed along the carriage shaft 34 in a main scanning direction, the ink (not shown) is ejected from the recording heads 38 and 40 toward the recording medium 32. Then, the recording medium 32 is conveyed by the conveying unit (not shown) in a sub-scanning direction. Thus, the image is recorded on the recording medium 32.

Any kind of recording medium may be used. Recording media each having ink absorbency, for example, recording media having no coat layer such as plain paper and recording media each having a coat layer, such as glossy paper and matte paper, may be used. In addition, recording media each having low ink absorbency or no ink absorbency, for example, a printed sheet, coated paper, a resin sheet and a resin film may be used. The ink of the present disclosure may be suitably used for applications in which an ink is directly applied to such recording medium to record an image.

According to one aspect of the present disclosure, there can be provided such an aqueous ink for ink jet recording including C.I. Pigment Orange 43 that the ejection stability is satisfactory, and an image having satisfactory color developability can be recorded, an ink cartridge containing the aqueous ink and an ink jet recording method. In addition, according to another aspect of the present disclosure, it is possible to provide an aqueous pigment dispersion that can be used in the production of an aqueous ink, a method for producing an aqueous pigment dispersion that can be used in the production of an aqueous ink, and a method for producing an aqueous ink using the aqueous dispersion obtained by the production method, the aqueous ink having the ejection stability is satisfactory, and an image having satisfactory color developability can be recorded.

### EXAMPLES

The present disclosure is described in more detail below by way of Examples and Comparative Examples. However, the present disclosure is by no means limited to Examples below, and various modifications are possible without departing from the gist of the present disclosure. In the description of the amounts of components, “part(s)” and “%” are by mass unless otherwise specified.

### Step A: Solvent Salt Milling

40 Parts of a raw material pigment, 200 parts of sodium chloride (average particle diameter: 10 μm) serving as a water-soluble inorganic salt and 40 parts of diethylene glycol serving as a water-soluble organic solvent were loaded into a kneader (product available under the product name “PBV-0.3” from Irie Shokai Co., Ltd.). C.I. Pigment Orange 43 (product available under the product name “PV FAST ORANGE GRL” from Heubach GmbH) having a BET specific surface area of 31 m²/g was used as the raw material pigment. After a temperature in the kneader was regulated to 40° C., kneading (solvent salt milling) was performed for 4 hours to provide a kneaded product containing the raw material pigment, the water-soluble inorganic salt and the water-soluble organic solvent.

Next, the kneaded product obtained above was taken out into a 2 L glass beaker. Then, 750 mL of a 1% sulfuric acid aqueous solution was added to the kneaded product, followed by stirring, to provide a suspension in which sodium chloride and diethylene glycol were dissolved. The suspension was centrifuged, and a precipitate was collected into a 3 L beaker. 2.5 L of ion-exchanged water was added to the precipitate, followed by stirring, and the resultant was left to stand still. An upper layer was discarded by decantation, and the remainder was centrifuged again to provide a precipitate. After this washing operation with ion-exchanged water was further repeated twice, the collected precipitate was dried to provide a pigment Pl having a solid content of 50% (water content ratio: 50%).

Pigments P2 to P4, P6 and P7 were obtained in the same manner as in the production of the pigment P1 except that: the raw material pigment was changed to C.I. Pigment Orange 43 of a product name of a raw material pigment shown in Table 1; and the kneading time (h) was changed as shown in Table 1. The pigment P5 was not subjected to solvent salt milling and was used in a subsequent step as a pigment having a solid content of 100% (water content ratio: 0%).
PV FAST ORANGE GRL
   (C.I. Pigment Orange 43, manufactured by Heubach GmbH, BET specific surface area: 31 m²/g)
Orange A-76SP
   (C.I. Pigment Orange 43, manufactured by Arimoto Chemical Co., Ltd., BET specific surface area: 24 m²/g)
PIGMENT ORANGE 4301
   (C.I. Pigment Orange 43, manufactured by Sanyo Color Works, Ltd., BET specific surface area: 43 m²/g)

TABLE 1
Preparation of Pigment

| Pigment | Product name | Kneading time (h) |
|---|---|---|
| P1 | PV FAST ORANGE GRL | 4 |
| P2 | Orange A-76SP | 4 |
| P3 | PV FAST ORANGE GRL | 8 |
| P4 | PV FAST ORANGE GRL | 2 |
| P5 | PIGMENT ORANGE 4301 | — |
| P6 | PV FAST ORANGE GRL | 9 |
| P7 | PV FAST ORANGE GRL | 1.5 |

### Step B: Dispersion

### [Synthesis of Resin Dispersant]

Monomers were polymerized by an ordinary method to synthesize water-soluble resins B1 to B10 that were random copolymers having the compositions and characteristics shown in Table 2. Thus, resins to be used as resin dispersants were prepared. An appropriate amount of a 10.0% potassium hydroxide aqueous solution was added to each of the resins to neutralize a carboxylic acid group that was an anionic group, and then an appropriate amount of water was further added to the resultant to provide a resin aqueous solution having a resin content of 20%. The resin was dissolved in tetrahydrofuran to prepare a sample for measurement, and the acid value of the resin was measured by performing potentiometric titration through use of a potassium hydroxide-ethanol titrant with a potentiometric titrator (product available under the product name “AT510” from Kyoto Electronics Manufacturing Co., Ltd.). The weight-average molecular weight of each of the resins in terms of polystyrene measured by GPC was 10,000. The abbreviations of the monomers shown in Table 2 are as described below.
St: styrene
αMSt: α-methylstyrene
BA: n-butyl acrylate
AA: acrylic acid

TABLE 2
Preparation and Characteristics of Resin Dispersant

| | | | | | | Ratio of |
|---|---|---|---|---|---|---|
| | Monomer (%) | | | | Acid value | styrene-based |
| Resin | St | αMSt | BA | AA | (mgKOH/g) | monomer (%) |
| B1 | 45.0 | 25.0 | 6.9 | 23.1 | 180 | 70 |
| B2 | 75.0 | | 2.5 | 22.5 | 175 | 75 |
| B3 | 45.0 | 25.0 | 10.1 | 19.9 | 155 | 70 |
| B4 | 45.0 | 25.0 | 9.5 | 20.5 | 160 | 70 |
| B5 | 45.0 | 25.0 | 4.3 | 25.7 | 200 | 70 |
| B6 | 45.0 | 25.0 | 3.7 | 26.3 | 205 | 70 |
| B7 | 45.0 | 10.0 | 21.9 | 23.1 | 180 | 58 |
| B8 | 45.0 | 15.0 | 16.9 | 23.1 | 180 | 60 |
| B9 | 45.0 | 32.0 | | 23.0 | 179 | 77 |
| B10 | 45.0 | 34.0 | | 21.0 | 164 | 79 |

### [Dispersion]

A mixture containing a pigment, a resin and an aqueous medium whose kinds and amounts were shown in Table 3 was loaded into a high-pressure homogenizer (product available under the product name “STAR BURST MINI” from Sugino Machine Limited), and was subjected to dispersion treatment at a pressure of 230 MPa and the number of passes shown in Table 3 to provide each of pigment dispersions D1 to D18. One pass is defined as a process in which the entire amount of the mixture loaded is passed through the high-pressure homogenizer, which is a dispersing device, once.

TABLE 3
Preparation and Dispersion of Pigment Dispersion

| | | | Resin aqueous | | | | |
|---|---|---|---|---|---|---|---|
| | Pigment | | solution | | Aqueous medium | | Dispersion |
| | | Usage | | Usage | | Usage | treatment |
| Pigment | | amount | Kind of | amount | | amount | Number of |
| dispersion | Kind | (part(s)) | resin | (part(s)) | Kind | (part(s)) | passes |
| D1 | P1 | 30.0 | B1 | 7.5 | Ion-exchanged | 62.5 | 40 |
| | | | | | water | | |
| D2 | P2 | 30.0 | B1 | 7.5 | Ion-exchanged | 62.5 | 40 |
| | | | | | water | | |
| D3 | P1 | 30.0 | B2 | 7.5 | Ion-exchanged | 62.5 | 40 |
| | | | | | water | | |
| D4 | P3 | 30.0 | B1 | 7.5 | Ion-exchanged | 62.5 | 40 |
| | | | | | water | | |
| D5 | P4 | 30.0 | B1 | 7.5 | Ion-exchanged | 62.5 | 40 |
| | | | | | water | | |
| D6 | P1 | 30.0 | B1 | 7.5 | Ion-exchanged | 62.5 | 40 |
| | | | | | water | | |
| D7 | P1 | 30.0 | B3 | 7.5 | Ion-exchanged | 62.5 | 40 |
| | | | | | water | | |
| D8 | P1 | 30.0 | B4 | 7.5 | Ion-exchanged | 62.5 | 40 |
| | | | | | water | | |
| D9 | P1 | 30.0 | B5 | 7.5 | Ion-exchanged | 62.5 | 40 |
| | | | | | water | | |
| D10 | P1 | 30.0 | B6 | 7.5 | Ion-exchanged | 62.5 | 40 |
| | | | | | water | | |
| D11 | P1 | 30.0 | B7 | 7.5 | Ion-exchanged | 62.5 | 40 |
| | | | | | water | | |
| D12 | P1 | 30.0 | B8 | 7.5 | Ion-exchanged | 62.5 | 40 |
| | | | | | water | | |
| D13 | P1 | 30.0 | B9 | 7.5 | Ion-exchanged | 62.5 | 40 |
| | | | | | water | | |
| D14 | P1 | 30.0 | B10 | 7.5 | Ion-exchanged | 62.5 | 40 |
| | | | | | water | | |
| D15 | P5 | 15.0 | B1 | 7.5 | Ion-exchanged | 77.5 | 60 |
| | | | | | water | | |
| D16 | P6 | 30.0 | B1 | 7.5 | Ion-exchanged | 62.5 | 40 |
| | | | | | water | | |
| D17 | P7 | 30.0 | B1 | 7.5 | Ion-exchanged | 62.5 | 40 |
| | | | | | water | | |
| D18 | P1 | 30.0 | B1 | 7.5 | Ion-exchanged | 62.5 | 40 |
| | | | | | water | | |

### Step C: Ultrafiltration

### [Ultrafiltration]

Each of the pigment dispersions obtained by the above-mentioned dispersion treatment was subjected to ultrafiltration treatment at the number of passes shown in Table 4, and the replenishment of ion-exchanged water was adjusted to provide each of aqueous pigment dispersions D1 to D18 having a pigment content of 15%. In the ultrafiltration treatment, an ultrafiltration device including a hollow fiber filter (product available under the product name “S04-E070-05-N”, molecular weight cut off: 70 kDa, from Repligen) having a container with a stirrer, a liquid feed pump and a pressure gauge and a line for replenishing the ion-exchange water was used. When the amount of the permeate recovered by ultrafiltration is equal to the amount of the pigment dispersion subjected to the treatment, it is regarded as one pass.

### [Absorbance Ratio]

Each of the aqueous pigment dispersions obtained above was diluted by 10,000 times with ion-exchanged water, and an absorbance ratio represented by the following equation (1) was calculated by measuring an absorption spectrum in a wavelength range of from 200 nm to 800 nm. In the measurement of the absorption spectrum, a spectrophotometer (product available under the product name “U-3300” from Hitachi, Ltd.) was used.

$$Absorbance ratio = absorbance at peak around wavelength of 532 nm / absorbance at peak around wavelength of 496 nm \qquad ( 1 )$$

[Absorbance after Centrifugation]

For each of the aqueous pigment dispersions obtained above, a sample was prepared by diluting the aqueous pigment dispersion to a pigment content of 1.5%, and 6.00 g of the sample was injected into a centrifuge tube. After that, centrifugation was performed at 217,000 G for 30 minutes. After the completion of the centrifugation, 50% by mass (3.00 g) of an upper layer of the sample was collected, and an absorption spectrum was measured in a wavelength range of 350 nm or more to 550 nm or less. In the centrifugation, a centrifuge (product available under the product name “Optima MAX-XP Ultracentrifuge” from Beckman Coulter, Inc.) and a rotor (product available under the product name “MLA-80” from Beckman Coulter, Inc.) were used. In the measurement of the absorption spectrum, a spectrophotometer (product available under the product name “U-3300” from Hitachi, Ltd.) was used.

TABLE 4
Ultrafiltration and Physical Properties
of Aqueous Pigment Dispersion

| | Ultrafiltration | | |
|---|---|---|---|
| Aqueous pigment | treatment | Absorbance | Absorbance after |
| dispersion | Number of passes | ratio | centrifugation |
| D1 | 4 | 1.05 | 0.15 |
| D2 | 4 | 1.05 | 0.16 |
| D3 | 4 | 1.05 | 0.15 |
| D4 | 4 | 0.95 | 0.17 |
| D5 | 4 | 1.15 | 0.14 |
| D6 | 3 | 1.05 | 0.19 |
| D7 | 4 | 1.05 | 0.19 |
| D8 | 4 | 1.05 | 0.17 |
| D9 | 4 | 1.05 | 0.16 |
| D10 | 4 | 1.05 | 0.16 |
| D11 | 4 | 1.05 | 0.19 |
| D12 | 4 | 1.05 | 0.16 |
| D13 | 4 | 1.05 | 0.16 |
| D14 | 4 | 1.05 | 0.18 |
| D15 | 4 | 1.10 | 0.15 |
| D16 | 4 | 0.94 | 0.17 |
| D17 | 4 | 1.16 | 0.14 |
| D18 | 2 | 1.05 | 0.20 |

### Preparation of Ink

The respective components (unit: %) shown in Table 5-1 and Table 5-2 were mixed with each of the aqueous pigment dispersions of kinds shown in the upper row of Table 5-1 and Table 5-2, followed by sufficient stirring. Then, the resultant was filtered under pressure through a microfilter having a pore size of 2.5 um to prepare each ink. The “Acetylenol E100” shown in Table 5-1 and Table 5-2 is the product name of a nonionic surfactant (manufactured by Kawaken Fine Chemicals Co., Ltd.). Absorbance ratio of the prepared ink was measured in the same manner as that of the aqueous pigment dispersion except that the ink was used instead of the aqueous pigment dispersion and the ink was diluted 2,000 times with ion-exchanged water. In addition, absorbance ratio after centrifugation of the prepared ink was measured in the same manner as that of the aqueous pigment dispersion except that the ink was used instead of the aqueous pigment dispersion. As a result, the absorbance ratio of the inks and the absorbance after centrifugation of the inks were both similar to those of the aqueous pigment dispersions used in the inks (see Table 4).

TABLE 5-1
Composition of Ink

| | Example | | | | | | | | |
|---|---|---|---|---|---|---|---|---|---|
| | 1 | 2 | 3 | 4 | 5 | 6 | 7 | 8 | 9 |
| Kind of aqueous | D1 | D2 | D3 | D4 | D5 | D6 | D7 | D8 | D9 |
| pigment | | | | | | | | | |
| dispersion | | | | | | | | | |
| Aqueous | 20.0 | 20.0 | 20.0 | 20.0 | 20.0 | 20.0 | 20.0 | 20.0 | 20.0 |
| pigment | | | | | | | | | |
| dispersion | | | | | | | | | |
| Glycerin | 7.0 | 7.0 | 7.0 | 7.0 | 7.0 | 7.0 | 7.0 | 7.0 | 7.0 |
| Triethylene | 2.0 | 2.0 | 2.0 | 2.0 | 2.0 | 2.0 | 2.0 | 2.0 | 2.0 |
| glycol | | | | | | | | | |
| Acetylenol E100 | 1.0 | 1.0 | 1.0 | 1.0 | 1.0 | 1.0 | 1.0 | 1.0 | 1.0 |
| Ion-exchanged | 70.0 | 70.0 | 70.0 | 70.0 | 70.0 | 70.0 | 70.0 | 70.0 | 70.0 |
| water | | | | | | | | | |

TABLE 5-2
Composition of Ink

| | | | | | | | Comparative | | |
|---|---|---|---|---|---|---|---|---|---|
| | Example | | | | | | Example | | |
| | 10 | 11 | 12 | 13 | 14 | 15 | 1 | 2 | 3 |
| Kind of aqueous | D10 | D11 | D12 | D13 | D14 | D15 | D16 | D17 | D18 |
| pigment | | | | | | | | | |
| dispersion | | | | | | | | | |
| Aqueous | 20.0 | 20.0 | 20.0 | 20.0 | 20.0 | 20.0 | 20.0 | 20.0 | 20.0 |
| pigment | | | | | | | | | |
| dispersion | | | | | | | | | |
| Glycerin | 7.0 | 7.0 | 7.0 | 7.0 | 7.0 | 7.0 | 7.0 | 7.0 | 7.0 |
| Triethylene | 2.0 | 2.0 | 2.0 | 2.0 | 2.0 | 2.0 | 2.0 | 2.0 | 2.0 |
| glycol | | | | | | | | | |
| Acetylenol | 1.0 | 1.0 | 1.0 | 1.0 | 1.0 | 1.0 | 1.0 | 1.0 | 1.0 |
| E100 | | | | | | | | | |
| Ion-exchanged | 70.0 | 70.0 | 70.0 | 70.0 | 70.0 | 70.0 | 70.0 | 70.0 | 70.0 |
| water | | | | | | | | | |

### Evaluation

In the present disclosure, in the following evaluation criteria of each item, the levels “A” and “B” were defined as acceptable levels, and the level “C” was defined as an unacceptable level. The evaluation results are shown in Table 6.

### [Ejection Stability]

Each of the prepared inks was loaded into an ink cartridge, and the following evaluation was made with an ink jet recording apparatus (product available under the product name “PIXUS PRO-10S” from CANON KABUSHIKI KAISHA) having mounted thereon a recording head that ejected an ink through the action of thermal energy. In the above-mentioned ink jet recording apparatus, the recording duty of an image recorded under such a condition that eight ink droplets having a mass of 3.8 ng per droplet are applied to a unit region measuring 1/600 inch by 1/600 inch is defined as 100%. An A4-size solid image having a recording duty of 50% was continuously recorded onto 300 sheets of a recording medium (plain paper available under the product name “PB PAPER” from CANON KABUSHIKI KAISHA) with the above-mentioned ink jet recording apparatus. Then, the states of defects in the images on the first and 300th sheets were visually observed, and the ejection stability of the ink was evaluated based on the evaluation criteria described below.
A: Recording on 300 sheets was possible, and there was no defect in the image on the 300th sheet.
B: Recording on 300 sheets was possible, and there was no blank area in the image on the 300th sheet, though there was a defect therein.
C: Recording on 300 sheets was possible, and there were a defect and a blank area in the image on the 300th sheet.

### [Color Developability]

A solid image (recording duty: 100%) measuring 200 mm by 200 mm was recorded onto glossy paper (product available under the product name “Premium Glossy Paper 2” from CANON KABUSHIKI KAISHA) with the above-mentioned ink jet recording apparatus. After the recorded solid image was left to stand for 1 day, a chroma C* and a hue angle “h” of the solid image were measured under the conditions of a light source D50 and a viewing angle of 2° with a spectrodensitometer (product available under the product name “FD-7” from Konica Minolta, Inc.), and the color developability of the image was evaluated based on the evaluation criteria described below.
A: The chroma C* was 115 or more, and the hue angle “h” was less than 60°.
B: The chroma C* was 110 or more to less than 115, or the hue angle “h” was 60° or more, though the chroma C* was 115 or more.
C: The chroma C* was less than 110.

TABLE 6
Evaluation Results

| | | Ejection stability | Color developability |
|---|---|---|---|
| Example | 1 | A | A |
| | 2 | A | A |
| | 3 | A | A |
| | 4 | B | A |
| | 5 | A | B |
| | 6 | B | A |
| | 7 | B | A |
| | 8 | A | A |
| | 9 | A | A |
| | 10 | A | B |
| | 11 | B | A |
| | 12 | A | A |
| | 13 | A | A |
| | 14 | B | A |
| | 15 | A | A |
| Comparative | 1 | C | B |
| Example | 2 | B | C |
| | 3 | C | B |

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-087315, filed May 29, 2024, and Japanese Patent Application No. 2025-085557, filed May 22, 2025, which are hereby incorporated by reference herein in their entirety.

What is claimed is:

1. An aqueous ink for ink jet recording, comprising:
a pigment;
a resin dispersant; and
an aqueous medium, wherein the pigment contains C.I. Pigment Orange 43, wherein the aqueous ink has an absorbance ratio of 0.95 or more to 1.15 or less, which is represented by the following equation (1):
$$absorbance ratio = absorbance at peak around wavelength of 532 nm / absorbance at peak around wavelength of 496 nm , and \qquad ( 1 )$$
wherein an absorbance of 50% by mass of an upper layer when the aqueous ink is centrifuged at 217,000 G for 30 minutes at a pigment content of 1.5% by mass is less than 0.20 in a wavelength range of 350 nm or more to 550 nm or less.

2. The aqueous ink according to claim 1, wherein the resin dispersant has an acid value of 160 mgKOH/g or more to 200 mgKOH/g or less.

3. The aqueous ink according to claim 1, wherein the resin dispersant is a copolymer having a unit derived from a styrene-based monomer and a unit derived from (meth)acrylic acid, and wherein a ratio (% by mass) of the unit derived from the styrene-based monomer to a total mass of the resin dispersant is 60% by mass or more to 77% by mass or less.

4. An ink cartridge comprising:
an ink; and
an ink storage portion configured to store the ink,
wherein the ink comprises the aqueous ink according to claim 1.

5. An ink jet recording method of recording an image onto a recording medium by ejecting an ink from an ink jet recording head, wherein the ink comprises the aqueous ink according to claim 1.

6. An aqueous pigment dispersion used in a production of an aqueous ink for ink jet recording, comprising:
a pigment;
a resin dispersant; and
an aqueous medium,
wherein the pigment contains C.I. Pigment Orange 43,
wherein the aqueous pigment dispersion has an absorbance ratio of 0.95 or more to 1.15 or less, which is represented by the following equation (1):
$$absorbance ratio = absorbance at peak around wavelength of 532 nm / absorbance at peak around wavelength of 496 nm , and \qquad ( 1 )$$
wherein an absorbance of 50% by mass of an upper layer when the aqueous pigment dispersion is centrifuged at 217,000 G for 30 minutes at a pigment content of 1.5% by mass is less than 0.20 in a wavelength range of 350 nm or more to 550nm or less.

7. A method for producing an aqueous pigment dispersion used in a production of an aqueous ink for ink jet recording, comprising:
a step A of performing solvent salt milling by mixing at least a raw material pigment, an inorganic salt and an organic solvent;
a step B of subjecting a mixture containing the pigment obtained in the step A, a resin dispersant and an aqueous medium to dispersion treatment to provide a dispersion; and
a step C of subjecting the dispersion obtained in the step B to ultrafiltration treatment to provide an aqueous pigment dispersion,
wherein the raw material pigment contains C.I. Pigment Orange 43 having a BET specific surface area of 35 m²/g or less, wherein the aqueous pigment dispersion has an absorbance ratio of 0.95 or more to 1.15 or less, which is represented by the following equation (1):
$$absorbance ratio = absorbance at peak around wavelength of 532 nm / absorbance at peak around wavelength of 496 nm , and \qquad ( 1 )$$
wherein an absorbance of 50% by mass of an upper layer when the aqueous pigment dispersion is centrifuged at 217,000 G for 30 minutes at a pigment content of 1.5% by mass is less than 0.20 in a wavelength range of 350 nm or more to 550nm or less.

8. A method for producing an aqueous ink for ink jet recording, comprising:
mixing the aqueous pigment dispersion produced by the method according to claim 7 and another ink component.
